(19) United States
(12) Patent Application Publication
(10) Pub. No.: US 2022/0014818 A1
(43) Pub. Date: Jan. 13, 2022

(54) MEDIA STREAMS

(71) Applicant: ARRIS Enterprises LLC, Suwanee, GA (US)

(72) Inventor: Krishna Prasad Panje, Bangalore (IN)

(21) Appl. No.: 17/217,549

(22) Filed: Mar. 30, 2021

Related U.S. Application Data
(60) Provisional application No. 63/072,747, filed on Aug. 31, 2020.

(30) Foreign Application Priority Data
Jul. 13, 2020 (IN) 202031029779
Jul. 13, 2020 (IN) 202031029782

(51) Int. Cl. H04N 21/4402; H04N 21/2187; H04N 21/643; H04N 21/845; H04N 21/61; H04N 21/438

(52) U.S. Cl. CPC H04N 21/4402; H04N 21/2187; H04N 21/643; H04N 21/8455; H04N 21/6118; H04N 21/438; H04N 21/8456

(57) ABSTRACT

In one embodiment, a system for modifying a video stream includes a video player receiving a video stream encoded as a series of non-predictive video frames and predictive video frames. The video player decodes the frames and is repositioned at a playback time from a current time to a different time in the video stream. In one embodiment, the video player uses a time reference table to identify a position in a variant of the video stream corresponding to the different time that is encoded as a non-predictive video frame. The video player receives the variant of the video stream in response to identifying the position. In another embodiment, a system for modifying a video stream includes a video player receiving a video stream encoded as a series of non-predictive video frames and predictive video frames. The video player decodes the frame of the video stream and provides the decoded video stream to a display. The video player repositions a playback time from a current time to a different time in the video stream. The different time is provided to a video encoder of the video stream which encodes the video stream based upon the different time, where a frame corresponding to the different time is encoded as a non-predictive video frame.

### CROSS REFERENCE TO RELATED APPLICATIONS

This application claims the benefit of U.S. Provisional Patent Application Ser. No. 63/072,747 filed Aug. 31, 2020; claims the benefit of U.S. Provisional Patent Application Ser. No. 63/702,741 filed Aug. 31, 2020; claims the benefit of India Patent Application Serial Number 202031029782 filed Jul. 13, 2020; claims the benefit of India Patent Application Serial Number 202031029779 filed Jul. 13, 2020.

### BACKGROUND

The subject matter of this application relates to media streams.

Cable system operators and other network operators provide streaming media to a gateway device for distribution in a consumer's home. The gateway device offers a singular point to access different types of content, such as live content, on-demand content, online content, over-the-top content, and content stored on a local or a network based digital video recorder. The gateway enables a connection to home network devices. The connection may include, for example, connection to a WiFi router or a Multimedia over Coax Alliance (MoCA) connection that provide IP over in-home coaxial cabling.

Consumers prefer to use devices that are compliant with standard protocols to access streaming video from the gateway device, so that all the devices within the home are capable of receiving streaming video content provided from the same gateway device. HTTP Live Streaming (HLS) is an adaptive streaming communications protocol created by Apple to communicate with iOS, Apple TV devices, and Macs running OSX Snow Leopard or later. HLS is capable of distributing both live and on-demand files and is the sole technology available for adaptively streaming to Apple devices.

### BRIEF DESCRIPTION OF THE DRAWINGS

For a better understanding of the invention, and to show how the same may be carried into effect, reference will now be made, by way of example, to the accompanying drawings, in which:

FIG. 1 illustrates an overview of a cable system.

FIG. 2 illustrates HLS streaming video content.

FIG. 3 illustrates a HLS mater playlist.

FIG. 4 illustrates a HLS VOD playlist.

FIG. 5 illustrates an event playlist.

FIG. 6 illustrates an updated event playlist.

FIG. 7 illustrates a sliding window playlist.

FIG. 8 illustrates an updated sliding window playlist.

FIG. 9 illustrates a further updated sliding window playlist.

FIG. 10 illustrates a series of I, P, and B frames.

FIG. 11 illustrates a repositioning technique.

FIG. 12 illustrates a set of variants, each including a series of I, P, and B frames.

FIG. 13 illustrates a video player and a time reference table.

FIG. 14 illustrates another repositioning technique that uses the time reference table.

FIG. 15 illustrates video players with a central database.

FIG. 16 illustrates an encoding system based upon reposition data.

FIG. 17 illustrates a video player rendering thumbnails.

### DETAILED DESCRIPTION

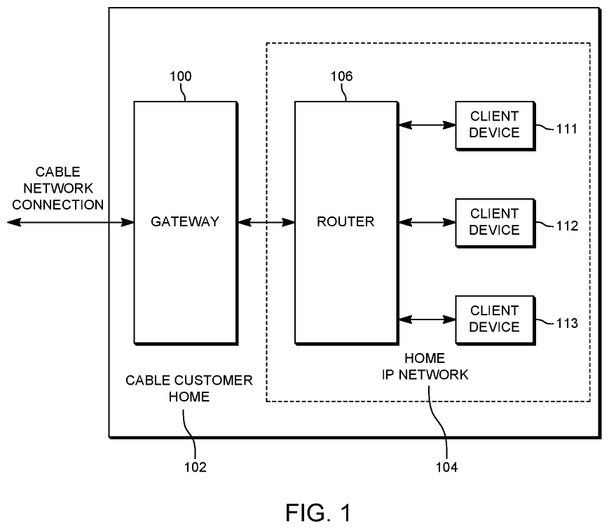

Referring to FIG. 1, a cable system overview is illustrated with a cable network connection provided to a gateway 100 of a cable customer's home 102. The cable network connection provided to the gateway 100 may be from a cable system operator or other streaming content provider, such as a satellite system. The gateway 100 provides content to devices in a home network 104 in the consumer's home 102. The home network 104 may include a router 106 that receives IP content from the gateway 100 and distributes the content over a WiFi or a cable connection to client devices 111, 112, 113. The router 106 may be included as part of the gateway 100. In general, the cable network connection, or other types of Internet or network connection, provides streaming media content to client devices in any suitable manner. The streaming media content may be in the form of HTTP Live Streaming (HLS), Dynamic Adaptive Streaming over HTTP (DASH), or otherwise.

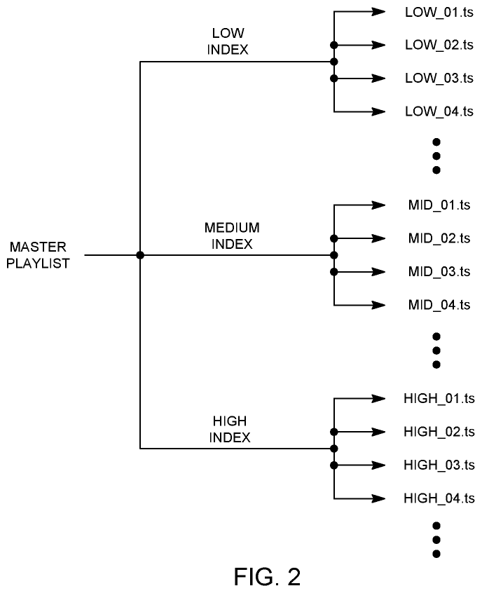

Referring to FIG. 2, at a high level HLS enables adaptive streaming of video content, by creating multiple files for distribution to a media player, which adaptively changes media streams being obtained to optimize the playback experience. HLS is a HTTP-based technology so that no streaming server is required, so all the switching logic resides on the player. To distribute content to HLS players, the video content is encoded into multiple files at different data rates and divided into short chucks, each of which is typically between 5-10 seconds long. The chunks are loaded onto a HTTP server along with a text based manifest file with a .M3U8 extension that directs the player to additional manifest files for each of the encoded media streams. The short video content media files are generally referred to as “chunked” files.

The player monitors changing bandwidth conditions over time to the player. If the change in bandwidth conditions indicates that the stream should be changed to a different bit rate, the player checks the master manifest file for the location of additional streams having different bit rates. Using a stream specific manifest file for a selected different stream, the URL of the next chuck of video data is requested. In general, the switching between video streams by the player is seamless to the viewer.

A master playlist (e.g., manifest file) describes all of the available variants for the content. Each variant is a version of the stream at a particular bit rate and is contained in a separate variant playlist (e.g., manifest file). The client switches to the most appropriate variant based on the measured network bit rate to the player. The master playlist isn't typically re-read. Once the player has read the master playlist, it assumes the set of variants isn't changing. The stream ends as soon as the client sees the EXT-X-ENDLIST tag on one of the individual variant playlists.

For example, the master playlist may include a set of three variant playlists. A low index playlist, having a relatively low bit rate, may reference a set of respective chunk files. A medium index playlist, having a medium bit rate, may reference a set of respective chunk files. A high index playlist, having a relatively high bit rate, may reference a set of respective chunk files.

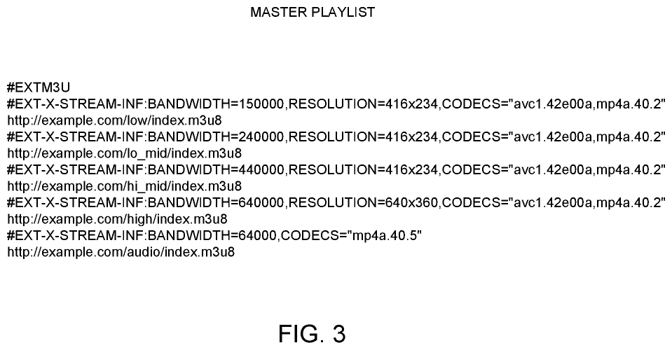

Referring to FIG. 3, an exemplary master playlist that defines five different variants is illustrated. Exemplary tags used in the master playlist may include one or more of the following.

EXTM3U: Indicates that the playlist is an extended M3U file. This type of file is distinguished from a basic M3U file by changing the tag on the first line to EXTM3U. All HLS playlists start with this tag.

EXT-X-STREAM-INF: Indicates that the next URL in the playlist file identifies another playlist file. The EXT-X-STREAM-INF tag has the following parameters.

AVERAGE-BANDWIDTH: An integer that represents the average bit rate for the variant stream.

BANDWIDTH: An integer that is the upper bound of the overall bitrate for each media file, in bits per second. The upper bound value is calculated to include any container overhead that appears or will appear in the playlist.

FRAME-RATE: A floating-point value that describes the maximum frame rate in a variant stream.

HDCP-LEVEL: Indicates the type of encryption used. Valid values are TYPE-0 and NONE. Use TYPE-0 if the stream may not play unless the output is protected by HDCP.

RESOLUTION: The optional display size, in pixels, at which to display all of the video in the playlist. This parameter should be included for any stream that includes video.

VIDEO-RANGE: A string with valid values of SDR or PQ. If transfer characteristic codes 1, 16, or 18 aren't specified, then this parameter must be omitted.

CODECS: (Optional, but recommended) A quoted string containing a comma-separated list of formats, where each format specifies a media sample type that's present in a media segment in the playlist file. Valid format identifiers are those in the ISO file format name space defined by RFC 6381 [RFC6381].

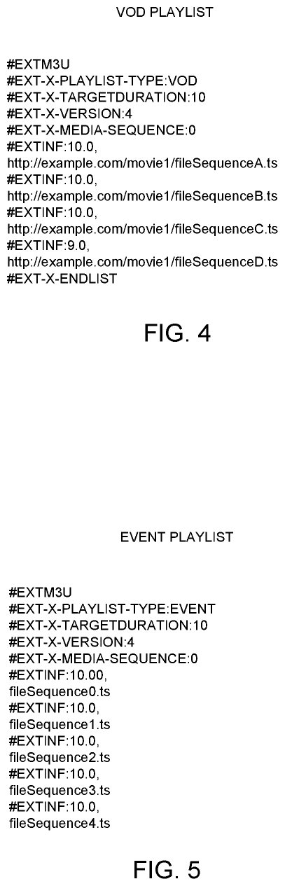

Referring to FIG. 4, one of the types of video playlists include a video on demand (VOD) playlist. For VOD sessions, media files are available representing the entire duration of the presentation. The index file is static and contains a complete list of URLs to all media files created since the beginning of the presentation. This kind of session allows the client full access to the entire program.

Exemplary tags used in the VOD playlist may include one or more of the following.

EXTM3U: Indicates that the playlist is an extended M3U file. This type of file is distinguished from a basic M3U file by changing the tag on the first line to EXTM3U. All HLS playlists start with this tag.

EXT-X-PLAYLIST-TYPE: Provides mutability information that applies to the entire playlist file. This tag may contain a value of either EVENT or VOD. If the tag is present and has a value of EVENT, the server must not change or delete any part of the playlist file (although it may append lines to it). If the tag is present and has a value of VOD, the playlist file must not change.

EXT-X-TARGETDURATION: Specifies the maximum media-file duration.

EXT-X-VERSION: Indicates the compatibility version of the playlist file. The playlist media and its server must comply with all provisions of the most recent version of the IETF Internet-Draft of the HTTP Live Streaming specification that defines that protocol version.

EXT-X-MEDIA-SEQUENCE: Indicates the sequence number of the first URL that appears in a playlist file. Each media file URL in a playlist has a unique integer sequence number. The sequence number of a URL is higher by 1 than the sequence number of the URL that preceded it. The media sequence numbers have no relation to the names of the files.

EXTINF: A record marker that describes the media file identified by the URL that follows it. Each media file URL must be preceded by an EXTINF tag. This tag contains a duration attribute that's an integer or floating-point number in decimal positional notation that specifies the duration of the media segment in seconds. This value must be less than or equal to the target duration.

EXT-X-ENDLIST: Indicates that no more media files will be added to the playlist file.

The VOD playlist example in FIG. 4 uses full pathnames for the media file playlist entries. While this is allowed, using relative pathnames is preferable. Relative pathnames are more portable than absolute pathnames and are relative to the URL of the playlist file. Using full pathnames for the individual playlist entries often results in more text than using relative pathnames.

Referring to FIG. 5, an event playlist is specified by the EXT-X-PLAYLIST-TYPE tag with a value of EVENT. It doesn't initially have an EXT-X-ENDLIST tag, indicating that new media files will be added to the playlist as they become available.

Exemplary tags used in the EVENT playlist may include one or more of the following.

EXTM3U: Indicates that the playlist is an extended M3U file. This type of file is distinguished from a basic M3U file by changing the tag on the first line to EXTM3U. All HLS playlists start with this tag.

EXT-X-PLAYLIST-TYPE: Provides mutability information that applies to the entire playlist file. This tag may contain a value of either EVENT or VOD. If the tag is present and has a value of EVENT, the server must not change or delete any part of the playlist file (although it may append lines to it). If the tag is present and has a value of VOD, the playlist file must not change.

EXT-X-TARGETDURATION: Specifies the maximum media-file duration.

EXT-X-VERSION: Indicates the compatibility version of the playlist file. The playlist media and its server must comply with all provisions of the most recent version of the IETF Internet-Draft of the HTTP Live Streaming specification that defines that protocol version.

EXT-X-MEDIA-SEQUENCE: Indicates the sequence number of the first URL that appears in a playlist file. Each media file URL in a playlist has a unique integer sequence number. The sequence number of a URL is higher by 1 than the sequence number of the URL that preceded it. The media sequence numbers have no relation to the names of the files.

EXTINF: A record marker that describes the media file identified by the URL that follows it. Each media file URL must be preceded by an EXTINF tag. This tag contains a duration attribute that's an integer or floating-point number in decimal positional notation that specifies the duration of the media segment in seconds. This value must be less than or equal to the target duration.

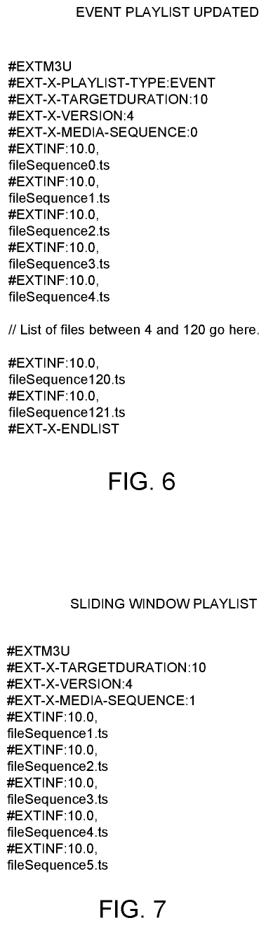

Items are not removed from the playlist when using the EVENT tag; rather new segments are appended to the end of the file. New segments are added to the end of the file until the event has concluded, at which time the EXT-X-ENDLIST tag may be appended. Referring to FIG. 6, the same playlist is shown after it's been updated with new media URIs and the event has ended. Event playlists are typically used when you want to allow the user to seek to any point in the event, such as for a concert or sports event.

Referring to FIG. 7, a live playlist (sliding window) is an index file that is updated by removing media URIs from the file as new media files are created and made available. The EXT-X-ENDLIST tag isn't present in the live playlist, indicating that new media files will be added to the index file as they become available.

Exemplary tags used in the live playlist may include one or more of the following.

EXTM3U: Indicates that the playlist is an extended M3U file. This type of file is distinguished from a basic M3U file by changing the tag on the first line to EXTM3U. All HLS playlists must start with this tag.

EXT-X-TARGETDURATION: Specifies the maximum media-file duration.

EXT-X-VERSION: Indicates the compatibility version of the playlist file. The playlist media and its server must comply with all provisions of the most recent version of the IETF Internet-Draft of the HTTP Live Streaming specification that defines that protocol version.

EXT-X-MEDIA-SEQUENCE: Indicates the sequence number of the first URL that appears in a playlist file. Each media file URL in a playlist has a unique integer sequence number. The sequence number of a URL is higher by 1 than the sequence number of the URL that preceded it. The media sequence numbers have no relation to the names of the files.

EXTINF: A record marker that describes the media file identified by the URL that follows it. Each media file URL must be preceded by an EXTINF tag. This tag contains a duration attribute that's an integer or floating-point number in decimal positional notation that specifies the duration of the media segment in seconds. This value must be less than or equal to the target duration. In addition, the live playlist can use an EXT-X-ENDLIST tag to signal the end of the content. Also, the live playlist preferably does not include the EXT-X-PLAYLIST-TYPE type.

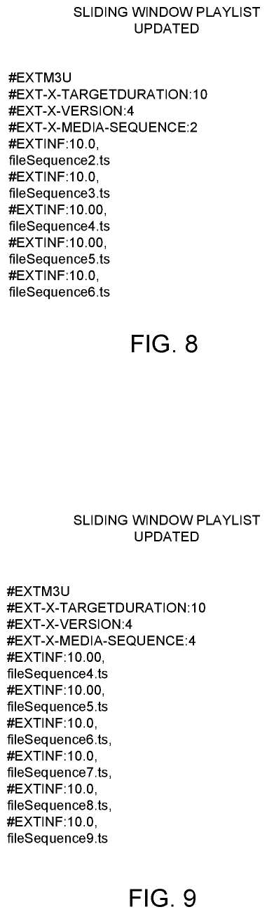

Referring to FIG. 8, the same playlist of FIG. 7 is shown after it has been updated with new media URIs.

Referring to FIG. 9, the playlist FIG. 8 continues to be updated as new media URIs are added.

Another adaptive streaming technology is referred to as Dynamic Adaptive Streaming over HTTP (DASH), also generally referred to as MPEG-DASH, that enables streaming of media content over the Internet delivered from conventional HTTP web servers. MPEG-DASH employs content broken into a sequence of small HTTP-based file segments, where each segment contains a short interval of playback time of content. The content is made available at a variety of different bit rates. While the content is being played back at an MPEG-DASH enabled player, the player uses a bit rate adaptation technique to automatically select the segment with the highest bit rate that can be downloaded in time for playback without causing stalls or re-buffering events in the playback. In this manner, a MPEG-DASH enabled video player can adapt to changing network conditions and provide high quality playback with fewer stalls or re-buffering events. DASH is described in ISO/IEC 23009-1:2014 “Information technology—Dynamic adaptive streaming over HTTP (DASH)—Part 1: Media presentation description and segment formats”, incorporated by reference herein in its entirety.

In many video streaming technologies, including MPEG-2, the video frames are encoded as a series of frames to achieve data compression and typically provided using a transport stream. Each of the frames of the video are typically compressed using either a prediction-based technique and a non-prediction based technique. An I frame is a frame that has been compressed in a manner that does not require other video frames to decode it. A P frame is a frame that has been compressed in a manner that uses data from a previous frame(s) to decode it. In general, a P frame is more highly compressed than an I frame. A B frame is a frame that has been compressed in a manner that uses data from both previous and forward frames to decode it. In general, a B frame is more highly compressed than a P frame. The video stream is therefore composed of a series of I, P, and B frames. MPEG-2 is described in ISO/IEC 13818-2:2013 “Information technology—Generic coding of moving pictures and associated audio information—Part 2: Video” incorporated by reference herein in its entirety. In some encoding technologies, including H.264, an IDR (instantaneous decoder refresh) frame is made up an intra code picture that also clears the reference picture buffer. However, for purposes of discussion the I frame and the IDR frame will be referred to interchangeably. In some encoding technologies, the granularity of the prediction types may be brought down to a slice level, which is a spatially distinct region of a frame that is encoded separately from any other regions in the same frame. The slices may be encoded as I-slices, P-slices, and B-slices in a manner akin to I frames, P-frames, and B-frames. However, for purposes of discussion I frame, P frame, and B frame are also intended to include I-slice, P-slice, and B-slice, respectively. In addition, the video may be encoded as a frame or a field, where the frame is a complete image and a field is a set of odd numbered or even numbered scan lines composing a partial image. However, for purposes of discussion both “frames” and “pictures” and “fields” are referred to herein as “frames”. H.264 is described in ITU-T (2019) “SERIES H: AUDIOVISUAL AND MULTIMEDIA SYSTEMS Infrastructure of audiovisual services—Coding of moving video”, incorporated by reference herein in its entirety.

When a user is watching a decoded video stream on a display, the user often wants reposition the playback of the video stream to a different position in the video content, such as a previous location of the video stream to display some video content again or a future location of the video stream to skip over the current content being displayed. In either case, the user selects a different location in the video stream, and as a result the video player repositions the location that is to be played either using video content in the buffer of the video player or otherwise requesting an appropriate segment of the video content from a video server, and in either case starting to decode and render a video stream based upon the position selected.

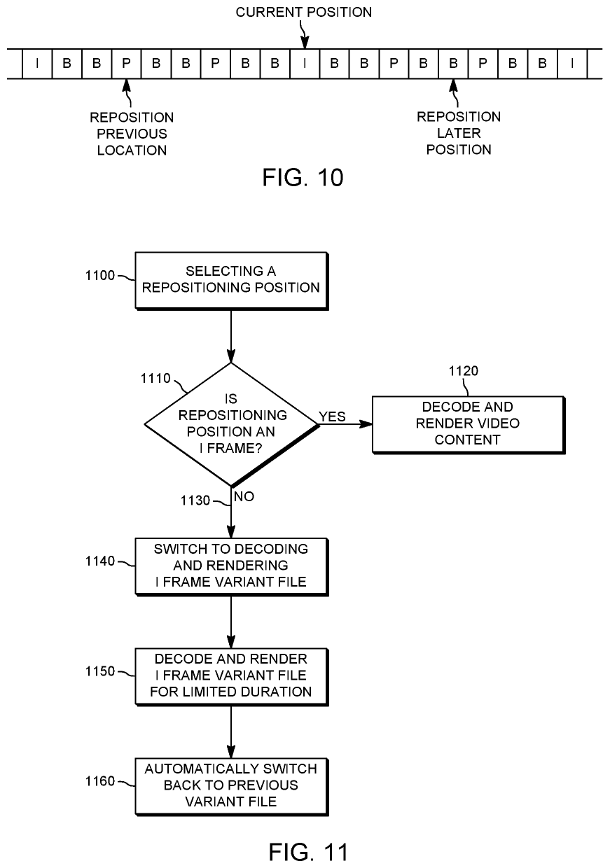

Referring to FIG. 10, often when this repositioning occurs the location selected often coincides with a P frame (or slice) or a B frame (or slice). To display the P frame, the player needs to decode one or more previous P frames, and an I frame. The decoding of a plurality of frames so that the P frame can be rendered, requires a substantial amount of time which results in a lag in the rendering of the video that is noticeable to the viewer. To display the B frame, the player needs to decode one or more previous or later P frames and decode one or more previous or later I frames. The decoding of a plurality of frames so that the B frame can be rendered, requires a substantial amount of time which results in a lag in the rendering of the video that is noticeable to the viewer. In the case that the repositioning occurs at a location that coincides with an I frame, only the I frame needs to be decoded, which does not require a substantial amount of time nor result in a substantial lag in the rendering of the video that is noticeable to the viewer.

Referring to FIG. 11, upon selecting to the repositioning position 1100, it is desirable that the video player is repositioned to a location that coincides with an I frame 1100 so that the video player decodes and renders the I frame so there is no substantial lag in rendering the video. In this case, the video player may decode the I frame and render the video content 1120 without any lag in the rendering of the video that is noticeable to the viewer. In the case that the video player is repositioned to a location that does not coincide with an I frame 1130 then it is desirable to switch to a different variant that includes a corresponding I frame at the repositioned location 1140. In HLS streams, a variant stream may include only I frames and is typically tagged using an EXT-X-I-FRAME-STREAM-INF tag that indicates a variant file containing only I frames. The EXT-X-I-FRAME-STREAM-INF may include an attribute list, including for example, bandwidth (identifies peak segment bit rate), average-bandwidth (identifies average segment bit rate), codecs, (identifies list of format types), resolution (identifies optimal pixel resolution), HDCP-level (indicates type of copy protection, if any), video (identifies a quoted string), and URI (identifies the I-frame file). Likewise, a similar stream exists for DASH. The video player switches to the I frame variant and decodes a corresponding I frame at the repositioned position 1140. The video player then decodes and renders the I frame variant file for a limited duration 1150, such as 1-3 seconds. After playing the I frame variant file for the limited duration, the video player automatically switches back to the previous variant file to continue decoding and rendering the video stream at the previous bitrate 1160. Preferably, the switch back to the previous variant file is selected in such a manner that the video stream is rendered without any lags in the presentation, such as switching back at a time that coincides with a subsequent I frame in the previous variant file. The bitrate of the I frame variant file may be greater or lesser than the bitrate of the previous variant file. The buffer in the video player is normally sufficient to accommodate differences in the bitrate for a temporary time period, such as 1-3 seconds.

In another embodiment, the system may include a plurality of I frame variant files, each of which have a different bitrate. In this manner, the video player may select the I frame variant file, from the plurality of I frame variant files, that most closely matches the current variant file being decoded and rendered.

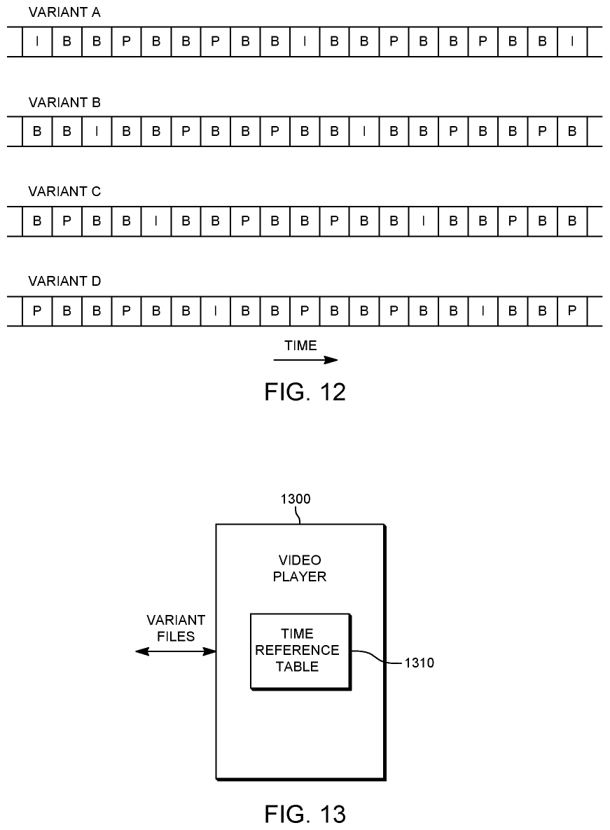

Referring to FIG. 12, in another embodiment, upon repositioning to the repositioning position, it is desirable that the video player is repositioned to a location that coincides with an I frame of another non I frame variant file so that the video player initially decodes an I frame. For example, a plurality of different variant files for the same video content, such as variant A, variant B, variant C, variant D, may have I frames arranged at staggered locations within the files.

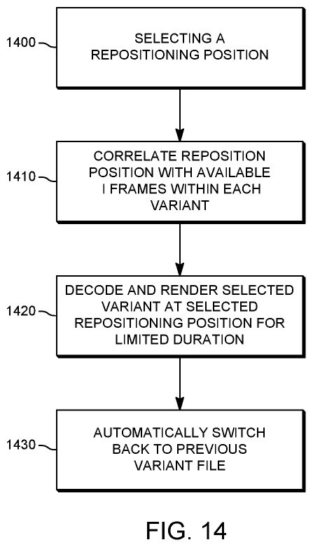

Referring to FIG. 13, a video player 1300 may include a time reference table 1310 that includes a look up table (or otherwise) indicating the location of the I frames in each of the other variants. Referring also to FIG. 14, the video player 1300 selects a repositioning position 1400 and correlates the repositioning position with available I frames within each of the variant files. If the repositioning position does not match an I frame within any of the variant files, then the video player may select a variant file with the closest I frame to the repositioning position 1410. The video player switches to the selected variant having the closest I frame and decodes and renders corresponding I frames starting at the repositioning position. The video player then decodes and renders the selected variant file for a limited duration 1420, such as 1-3 seconds. After decoding and rendering the selected variant file for the limited duration, the video player automatically switches back to the previous variant file 1430 to continue decoding and rendering the video stream at the previous bitrate. Preferably, the switch back to the previous variant file is selected in such a manner that the video stream is rendered without any lags in the presentation, such as switching back at a time that coincides to a subsequent I frame in the previous variant file. The bitrate of the selected variant file may be greater or lesser than the previous variant file. The buffer in the video player is normally sufficient to accommodate differences in the bitrate for a temporary time period, such as 1-3 seconds.

In another embodiment, the player may select the repositioning position. Either the video player and/or the content server may correlate the repositioning position with available I frames within each of the variant files or otherwise an I frame variant file. If the repositioning position does not match an I frame within any of the variant files, then the content server and/or the video player may select a variant file with the closest I frame to the repositioning position. The content server then provides to the video player the selected variant for a limited duration, such as 1-3 seconds. The video player switches to the selected variant and decodes and renders corresponding I frame(s) starting at the repositioning position. The video player then decodes and renders the selected variant file for a limited duration, such as 1-3 seconds. After decoding and rendering the selected variant file for the limited duration, the content server and/or player automatically switches back to the previous variant file to continue decoding and rendering the video stream at the previous bitrate.

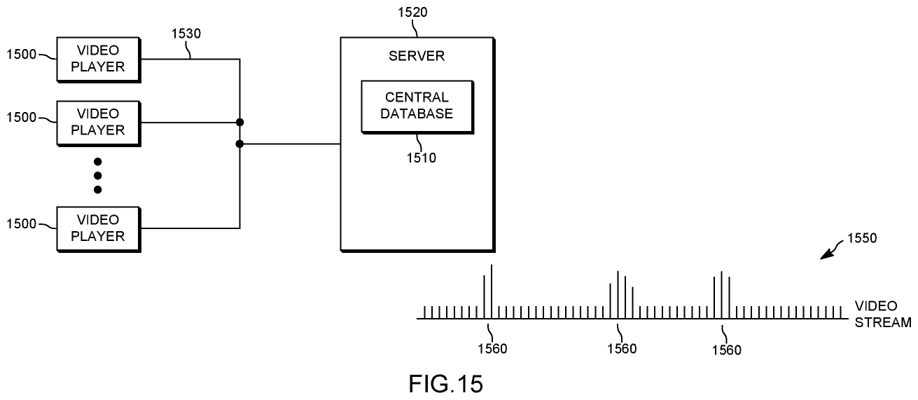

Referring to FIG. 15, it was determined that the collective actions of a plurality of different user's in their repositioning tendencies using their video players 1500 for a particular video content tends to identify those positions where there is an increased likelihood of any particular user repositioning the video stream to. One example is repositioning to the start of a slam dunk in basketball, or to the start of a run score in cricket. A central database 1510, on a server 1520 remote from the video players, collects data representative of where each of the user's repositioning occurs within the video stream through a network 1530, such as a cable network of the Internet. The repositioning location may be identified in any suitable manner, such as a presentation time stamp within the video stream. In this manner, each time a video player repositions the playback of the video stream, the repositioning location is provided to the central database 1520. The central database 1520 may process the received location information from all the video players 1500 in any suitable manner, such as a histogram 1540, to determine those locations that are likely to be a future destination location of a repositioning 1550.

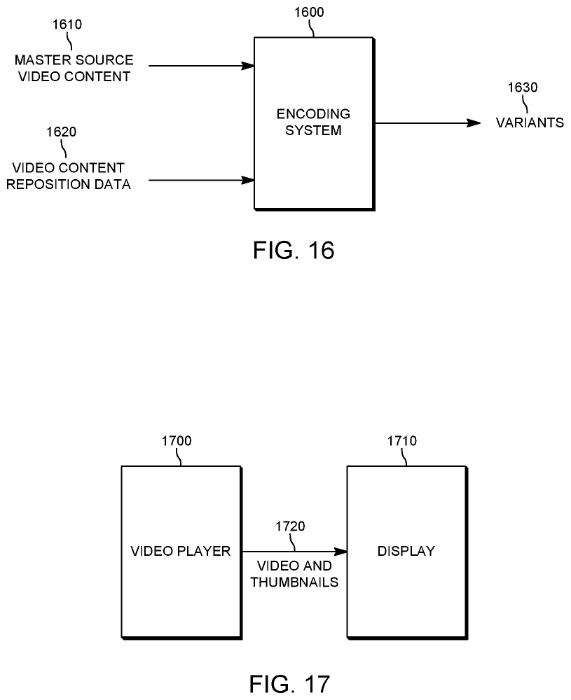

Referring to FIG. 16, based upon a threshold or any other suitable measure, an encoding system 1600 may determine those locations in a corresponding master source video content 1610 where the user is likely to reposition the video content to 1620. Based upon this information, the encoding system may re-encode the segment that includes the repositioning location(s) and encode one or more I frames at the reposition location(s). Alternatively, the encoding system may re-encode the segment starting with an immediately preceding I frame(s) to an immediately following I frame(s), to include an additional I frame(s) in the reposition location. This manner of encoding reduces the amount of encoding required. The encoding system may encode each of the variants, including the I frame at the reposition location(s) in the same manner and provide the variants 1630. Over time, with additional repositioning data becoming available, together with the re-encoding of the video, the number of I frames at the likely repositioning locations increases. In addition, by performing the re-encoding using the master source video content, the re-encoding does not result in loss of video quality.

Referring to FIG. 17, a video player 1700 may decode the received video content and provide a signal suitable to be rendered on a display 1710. The video player 1700 may receive, or otherwise request, or otherwise generate, thumbnails 1720 of the corresponding video content that is rendered on the display 1710. In this manner, a set of thumbnails may be presented together with the video content. By way of example, the thumbnails may be pre-generated by a server and provided to the video player 1700, such as using an over the top data stream. By way of example, the thumbnails may be generated by the video player based upon corresponding nearest I frames used by the video player 1700. By way of example, the thumbnails may be pre-generated by a server and provided to the video player 1700, upon request, such as using an over the top data stream. Alternatively, the thumbnails may be replaced by any other suitable content to be associated with different portions of the video stream, such as for example, audio files, images, textual information, network-based links, etc.

Moreover, each functional block or various features in each of the aforementioned embodiments may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

It will be appreciated that the invention is not restricted to the particular embodiment that has been described, and that variations may be made therein without departing from the scope of the invention as defined in the appended claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

I/We claim:

1. A method for modifying a video stream comprising:
(a) a video player receiving a video stream encoded as a series of non-predictive video frames and predictive video frames;
(b) said video player decoding said frames of said video stream and providing said decoded video stream to a display;
(c) said video player repositioning a playback time from a current time to a different time in said video stream;
(d) said video player using a time reference table to identify a position in a variant of said video stream corresponding to said different time, where the frame at said position is encoded as a non-predictive video frame;
(e) said video player receiving said variant of said video stream in response to said identifying said position.

2. The method of claim 1 further comprising said player receiving said video stream over a cable network.

3. The method of claim 1 wherein said non-predictive video frames include at least one of an I frame and an instantaneous decoder refresh frame.

4. The method of claim 1 wherein said predictive video frames includes at least one of a P frame and a B frame.

5. The method of claim 1 wherein said video stream is provided as a HTTP live streaming video stream.

6. The method of claim 1 wherein said video stream is provided as a dynamic adaptive streaming over HTTP video stream.

7. The method of claim 1 wherein said variant includes non-predictive video frames and predictive video frames.

8. The method of claim 1 wherein said variant includes only non-predictive video frames.

9. The method of claim 8 wherein said video player selects among a plurality of variants, each of which includes only non-predictive video frames.

10. The method of claim 1 wherein said video player selects among a plurality of variants, where each of said variant includes non-predictive video frames and predictive video frames.

11. The method of claim 10 wherein said video player selects one of said variants having a non-predictive video frame at said position.

12. The method of claim 1 further comprising said video player automatically switching back to said video stream.

13. The method of claim 12 wherein said switching occurs prior to 3 seconds

14. A method for modifying a video stream comprising:
(a) a video player receiving a video stream encoded as a series of non-predictive video frames and predictive video frames;
(b) said video player decoding said frames of said video stream and providing said decoded video stream to a display;
(c) said video player repositioning a playback time from a current time to a different time in said video stream;
(d) said video player identifying a position in a variant of said video stream corresponding to said different time, where said variant includes only non-predictive video frames;
(e) said video player receiving said variant of said video stream in response to identify said position;
(f) said video player automatically switching back to said video stream.

15. The method of claim 14 wherein said video player selects among a plurality of variants, each of which includes only non-predictive video frames.

16. The method of claim 14 wherein said switching occurs prior to 3 seconds.

17. A method for modifying a video stream comprising the steps of:
(a) a video player receiving a video stream encoded as a series of non-predictive video frames and predictive video frames;
(b) said video player decoding said frames of said video stream and providing said decoded video stream to a display;
(c) by said video player repositioning a playback time from a current time to a different time in said video stream;
(d) providing said different time to a video encoder of said video stream;
(e) encoding said video stream including a plurality of frames proximate said different time, wherein a frame corresponding to said different time is encoded as a non-predictive video frame, based upon said different time.

18. The method of claim 17 further comprising said player receiving said video stream over a cable network.

19. The method of claim 17 wherein said non-predictive video frames include at least one of an I frame and an instantaneous decoder refresh frame.

20. The method of claim 17 wherein said predictive video frames includes at least one of a P frame and a B frame.

21. The method of claim 17 wherein said video stream is provided as a HTTP live streaming video stream.

22. The method of claim 17 wherein said video stream is provided as a dynamic adaptive streaming over HTTP video stream.

23. The method of claim 17 further comprising a plurality of said video players receiving said video stream each of which repositioning a respectively playback time from a respective current time to a respective different time in said video stream.

24. The method of claim 23 further comprising providing each of said different times to said video encoder.

25. The method of claim 24 further comprising encoding said video stream including plurality of frames proximate said respective different times, wherein said different times is encoded as a non-predictive video frame.

26. The method of claim 25 wherein said encoded as a non-predictive video frame is based upon a plurality of said different times being having the same time.

27. The method of claim 17 wherein said providing said different time is based upon a presentation time stamp.

28. The method of claim 17 further comprising said video player providing a thumbnail along with said decoded video stream to said display.
